(19) United States
(12) Patent Application Publication
(10) Pub. No.: US 2011/0211271 A1
(43) Pub. Date: Sep. 1, 2011

(54) TRAPPING ELECTRON ASSISTED MAGNETIC RECORDING SYSTEM AND METHOD

(76) Inventors: Ka Wei Ng, Singapore (SG); Tiejun Zhou, Singapore (SG); Zhimin Yuan, Singapore (SG); Siang Huei Leong, Singapore (SG); Bo Liu, Singapore (SG)

(21) Appl. No.: 13/127,308

(22) PCT Filed: Nov. 2, 2009
(86) PCT No.: PCT/SG09/00399

§ 371 Date: May 3, 2011

Related U.S. Application Data
(60) Provisional application No. 61/193,177, filed on Nov. 3, 2008.

(51) Int. Cl. G11B 5/09

(52) U.S. Cl. 360/46; G9B/5.033

(57) ABSTRACT

A system and method for trapping electron assisted magnetic recording is disclosed. A magnetic recording system comprises a magnetic storage media, a read/write head, and a power supply for applying a negative DC electrical bias to the magnetic storage media in order to reduce the media switching field during the writing process. Recording is performed by applying an AC magnetic field produced by a write pole and a DC electrical field to assist in the writing. An embodiment of the invention uses a high electrical field to trap free electrons into an unfilled electronic shell of magnetic particles of the magnetic storage media, in particular, (3d) shell of transition elements, (4f) shell of rare earths of lanthanides series, and (5f) shell of actinides series. The trapped electron decreases anisotropy of magnetic particles due to reduced number of Bohr magnetron. As a result, a conventional head is able to write very high anisotropy magnetic storage media.

### FIELD OF THE INVENTION

This invention relates generally to a field of high-density magnetic data storage systems and methods, and more particularly to magnetic recording storage systems and methods including a hard disk drive to write to ultra high anisotropy magnetic storage media.

### BACKGROUND

In a hard disk drive (HDD) within a magnetic recording system, recording bits consist of one or many of single domain islands or particles. As recording density increases, area of each recording bit reduces proportionally together with volume of each recording particle. Magnetic energy of each magnetic particle also tends to reduce which contributes to thermal agitation at room temperature. This thermal agitation contributes to a higher probability to flip the magnetization direction of recorded particles which results in losing recorded data.

In order to prevent the thermal induced instability of recorded bits, anisotropy of magnetic particles has to be increased for keeping sufficient ratio of magnetic energy of the recording particle over the thermal energy. In this environment, a recording head of an HDD requires higher magnetic field to write to the magnetic storage media. When areal density approaches 1 Tb/in² and beyond, conventional write heads do not produce a sufficiently strong magnetic field to write the high anisotropy magnetic storage media with sufficient thermal stability. This kind of constraint is called superparamagnetic limit of a magnetic recording system. In magnetic recording systems, to achieve improved performance and increased areal density, there is a tradeoff among signal to noise ratio, thermal stability of recording bits, and writability. The most significant challenge to overcome superparamagnetic limit among the trilemma is how to increase the writability of magnetic recording systems.

To help maximize the areal density, another type of energy is required to be injected into a write bubble produced by conventional write head and assists it to write the magnetic particles with ultra high anisotropy. Attempts of assisted energy have been proposed such as thermal energy, microwave energy, exchange coupled composite (ECC) media or graded media, etc. The principle is to use extra energy to lower anisotropy barrier of magnetic particle and help the conventional writer head to record during the writing process. All prior attempts have low energy transmission efficiency and also cause many other engineering implementation difficulties.

For example, in the heat assisted magnetic recording (HAMR), ferromagnetic material of magnetic storage media is heated up close to Curie temperature and coercivity of it is significantly reduced for the magnetic recording head to write. Use of high temperature produces many engineering challenges and makes this technology hard to be implemented. The microwave assisted magnetic recording (MAMR) applies transverse oscillating field at an order of Larmor frequency of ferromagnetic medium material to assist magnetic recording head to write. As the Larmor frequency is proportional to the anisotropy field of ferromagnetic medium material, total writeability is limited.

Therefore, there is a need for a system and a method to lower the anisotropy barrier of magnetic particles and help the conventional writer head to record during the writing process in magnetic recording.

### SUMMARY

An aspect of the invention is a magnetic recording system comprising a magnetic storage media having a recording layer comprising a material having magnetic particles having a magnetic anisotropy energy that changes in the presence of an electrical field; a write head having a write pole for applying an alternating current (AC) magnetic field for writing magnetic information to the magnetic storage media; and a power supply for generating a negative direct current (DC) electrical bias between the magnetic storage media and the write head for applying a DC electric field to the recording layer to reduce the magnetic anisotropy energy and switching field of the material of the recording layer during the writing of magnetic information to the magnetic storage media.

In an embodiment, the magnetic recording system further comprises a soft magnetic underlayer under the recording layer. The magnetic storage media may further comprise an interlayer between the recording layer and the underlayer. The material of the recording layer may be CoCrP(SiO₂), CoCrPt(TiO₂), FePt and FePt with TiO₂, FePt and FePt with SiO₂, FePt and FePt with any oxide, CoPt and CoPt with TiO₂, CoPt and CoPt with SiO₂, CoPt and CoPt with any oxide, or the like.

In an embodiment, the negative electrical bias may be applied to the magnetic storage media to provide a source of free electrons for the magnetic particles in the recording layer to trap the electrons and fill an electronic shell of the magnetic particles to reduce the magnetic anisotropy energy of the magnetic particles. The magnetic particles that trap electrons also reduce the switching field of the recording layer for the write head to write magnetic information in the magnetic storage media. The magnetic particles that trap electrons also increase the signal to noise ratio of the recording layer magnetic particles. The magnetic particles that trap the free electrons are located at a surface of the recording layer.

An aspect of the invention is a magnetic recording method that comprises providing a magnetic storage media having a recording layer comprising a material having magnetic particles having a magnetic anisotropy energy that changes in the presence of an electrical field; applying an AC magnetic field for writing magnetic information to the magnetic storage media with a write head having a write pole; and generating a negative DC electrical bias between the magnetic storage media and the write head for applying a DC electric field to the recording layer to reduce the magnetic anisotropy energy and switching field of the material of the recording layer during the writing of magnetic information to the magnetic storage media.

An aspect of the invention is a magnetic storage media comprising a recording layer comprising a material having magnetic particles having a magnetic anisotropy energy that changes in the presence of an electrical field; and a soft magnetic underlayer under the recording layer.

An aspect of the invention is a hard disk drive comprising a magnetic storage media having a recording layer comprising a material having magnetic particles having a magnetic anisotropy energy that changes in the presence of an electrical field; and a write head having a write pole for applying an AC magnetic field for writing magnetic information to the magnetic storage media, and arranged to receive a power supply for generating a negative DC electrical bias between the magnetic storage media and the write head for applying a DC electric field to the recording layer to reduce the magnetic anisotropy energy and switching field of the material of the recording layer during the writing of magnetic information to the magnetic storage media.

### BRIEF DESCRIPTION OF THE DRAWINGS

In order that embodiments of the invention may be fully and more clearly understood by way of non-limitative examples, the following description is taken in conjunction with the accompanying drawings in which like reference numerals designate similar or corresponding elements, regions and portions, and in which:

FIG. 1 is a plan view of an actuator with a transducer head in relation to a magnetic storage media in a hard disk drive (HDD) in accordance with an embodiment of the invention;

FIG. 2A-2C shows a conceptual side view diagram showing a magnetic recording and reproduction device of the storage media and read/write head shown in FIG. 1 in more detail (FIG. 2A), the storage media and read/write head of FIG. 2A is shown in further detail (FIG. 2B), and a bottom view of read/write heads of FIG. 2B at air bearing surface is also shown (FIG. 2C) according to an embodiment of the invention;

FIG. 3 is a schematic drawing showing how a negative potential is applied to a magnetic storage media using conductive substrate in accordance with an embodiment of the invention;

FIG. 4A-4C shows electronic shell structure of iron atom as an example (FIG. 4A) with the normal shell structure of an iron atom, and two trapped free electrons stay in the iron atom (FIG. 4B) to show reduce the magnetic anisotropy of the iron atom (FIG. 4C) in accordance with an embodiment of the invention;

FIG. 5A-5B are graphs showing how magnetic anisotropy energy, Kᵤ, consisting of anisotropy field Hₖ and saturation magnetization Mₛ, changes with electron band filling for some of the magnetic materials for CoPt (FIG. 5A) and FePt (FIG. 5B) alloys, as examples, in accordance with an embodiment of the invention;

FIG. 6 shows how the switching field changes with the electron band filling in accordance with an embodiment of the invention;

FIG. 7 shows improved media performance by negatively biasing to magnetic storage media in accordance with an embodiment of the invention;

FIG. 8 shows how the negative bias is applied to the magnetic storage media using a glass substrate in accordance with an embodiment of the invention;

FIG. 9 shows a reduction of the anisotropy energy density Kᵤ of FePt versus the number of trapped electrons per unit cell of FePt in accordance with an embodiment of the invention;

FIG. 10 illustrates a switching mechanism of individual magnetic grains with an applied electric field induces electron trapping and reduced anisotropy of topmost layer in accordance with an embodiment of the invention;

FIG. 11 is a flow chart of a method in accordance with an embodiment of the invention;

FIG. 12 is a block diagram of a system in accordance with an embodiment of the invention;

FIG. 13 is a graph showing simulated hysteresis loops of a conventional magnetic storage media with different Kᵤ for the surface portion in accordance with an embodiment of the system; and

FIG. 14A-14B are graphs showing track profiles measured under different writer pole biases at a) 10 mA head writing current (FIG. 14A), and b) 40 mA head writing current (FIG. 14B), respectively, in accordance with an embodiment of the invention.

### DETAILED DESCRIPTION

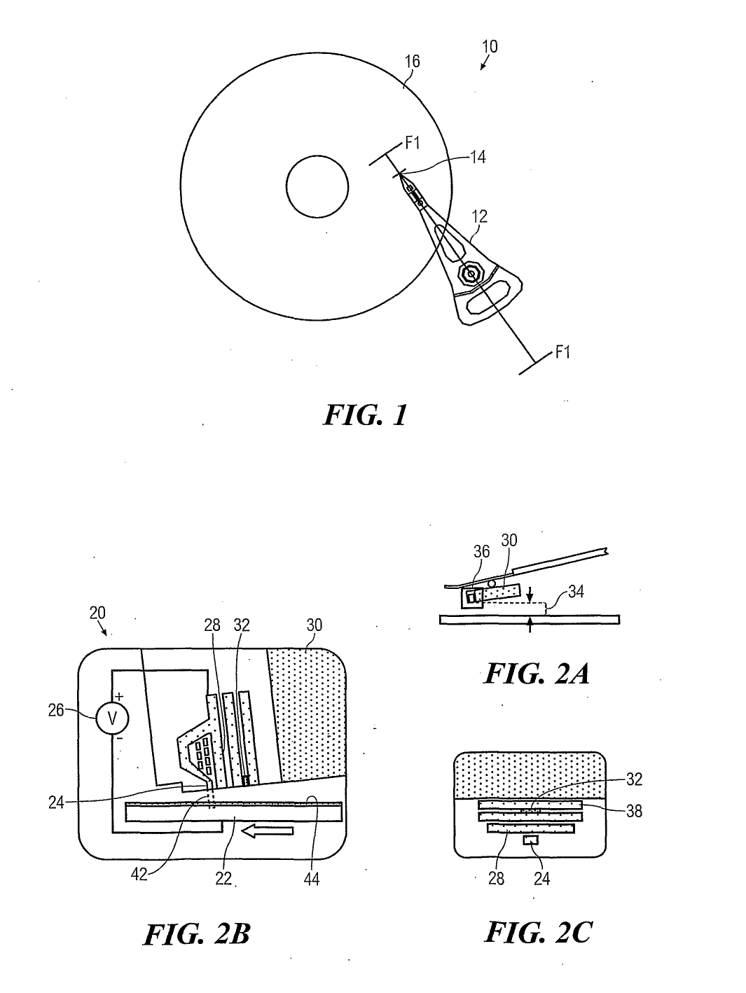

A hard disk drive (HDD) 10 consists of magnetic read/write heads 14 and magnetic storage media 16 as illustrated in FIG. 1. FIG. 1 is a plan view of an actuator 12 with a transducer head 14 in relation to a magnetic storage media in a hard disk drive in accordance with an embodiment of the invention. FIG. 2A is a conceptual side view diagram showing a magnetic recording and reproduction device of the magnetic storage media and read/write head shown in FIG. 1 in more detail. FIG. 2B shows the magnetic storage media and read/write head of FIG. 2A in further detail. FIG. 2C is a bottom view of read/write heads of FIG. 2B at air bearing surface according to an embodiment of the invention. FIG. 2A shows flying height or space between the magnetic storage media 22 and the read/write head 14. The area of FIG. 2A shown within box 36 is shown in more detail in FIG. 2B of the magnetic recording reproduction system 20. A power supply 26 is provided for generate a negative direct current (DC) electrical bias between the recording layer or magnetic layer 44 and the read/write head 14. A DC electric field 42 is applied to a recording layer 44 to reduce magnetic anisotropy energy and switching field of material of the recording layer 44 during writing of magnetic information to the magnetic storage media. The read/write head comprises a write pole 24, a return pole 28, a reader 32, and a reader shield 38 as shown in FIG. 2C.

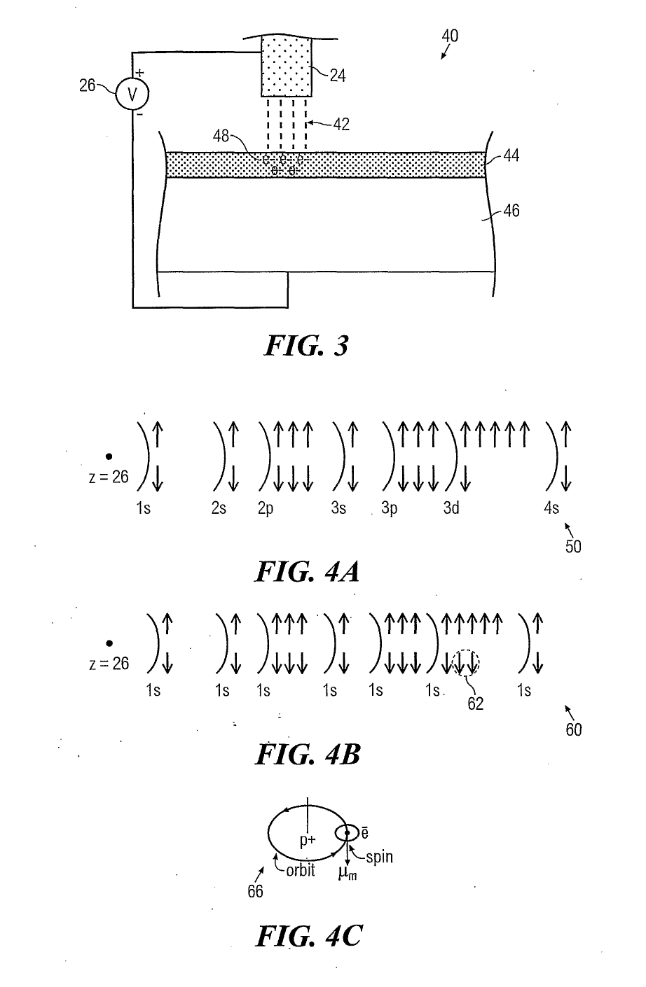

FIG. 3 is a schematic drawing to show a device 40 in accordance with an embodiment of the invention and to illustrate a negative DC electrical bias is applied directly to the magnetic storage media composed of for example CoCrPt with SiO₂ or TiO₂, or FePt/CoPt, etc. and the corresponding positive voltage is applied to the write pole 24. An electric field 42 is generated and the magnetic recording layer 44 comprises material having magnetic particles having magnetic anisotropy energy that changes in the presence of the electric field 42. The negative bias 26 is applied to a substrate 46 of magnetic storage media to provide a source of free electrons 48 for the magnetic particles in the recording layer 44 to trap the electrons 48 and fill an electronic shell of the magnetic particles to reduce the magnetic anisotropy energy of the magnetic particles.

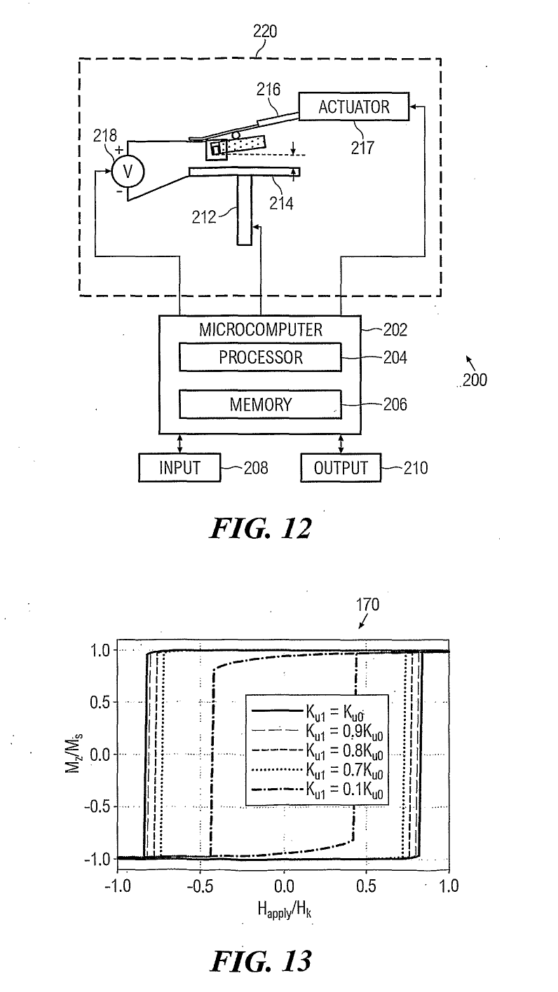

FIG. 12 is a block diagram of a system 200 in accordance with an embodiment of the invention. The system comprises a HDD assembly 220 having a spindle motor 212 for supporting the magnetic storage media 214. The HDD assembly has a read/write head 216 with actuator 217, and a power supply 218 to apply a negative DC electrical bias to the magnetic storage media is provided between the magnetic storage media and the write pole of the read/write head to reduce the media switching field during the writing process. The read/write head 216, actuator 217, power supply 218, the spindle motor 212, and other components of the HDD are electrically connected and controlled by a controller means 202 such as a microcomputer 202 having a processor 204 and memory 206 for controlling the HDD components. The processing means may have input means 208, such as the user data for recording and the control signals from computer system, and output 210, such as the reproduced user data and acknowledge signals from HDD to computer system, for allowing a user to control the HDD system 200.

Due to the relatively very low flying height of magnetic recording, for example less than 10 nm, the electrical field on the magnetic storage media surface is relatively very high, for example 4-5×10⁸ V/m with only a few volts bias applied, for example below 5V. Such high electrical field can trap enough electrons on the surface of the grains which compose of the magnetic storage media. The trapped electrons are localized and therefore can modify the magnetic properties of the magnetic storage media. Using an isolated iron atom as an example illustrated in FIG. 4A-B, the 4 up spins in 3d shell enable the iron atom 50 to be a ferromagnetic material. When a strong enough electrical field is applied, it is possible for two free electrons 62 to become trapped by this atom 60, the two electrons have to be filled into 3d shell and make this iron atom possesses two net up spins. As a result, the magnetic anisotropy of this iron atom is reduced by the trapped electrons 62 as shown in the graph 66 of FIG. 4C. A reduced magnetic anisotropy will cause a lower switching field and thereof make the magnetic storage media easier to write.

An embodiment of the invention uses a high electrical field to trap the free electrons into an unfilled electronic shell of magnetic particles, in particular, the 3d shell of transition elements, 4f shell of rare earths of lanthanides series, and 5f shell of actinides series. The trapped electron decreases the anisotropy of magnetic particles due to the reduced number of Bohr magnetron. As a result, the conventional head is able to write very high anisotropy magnetic storage media.

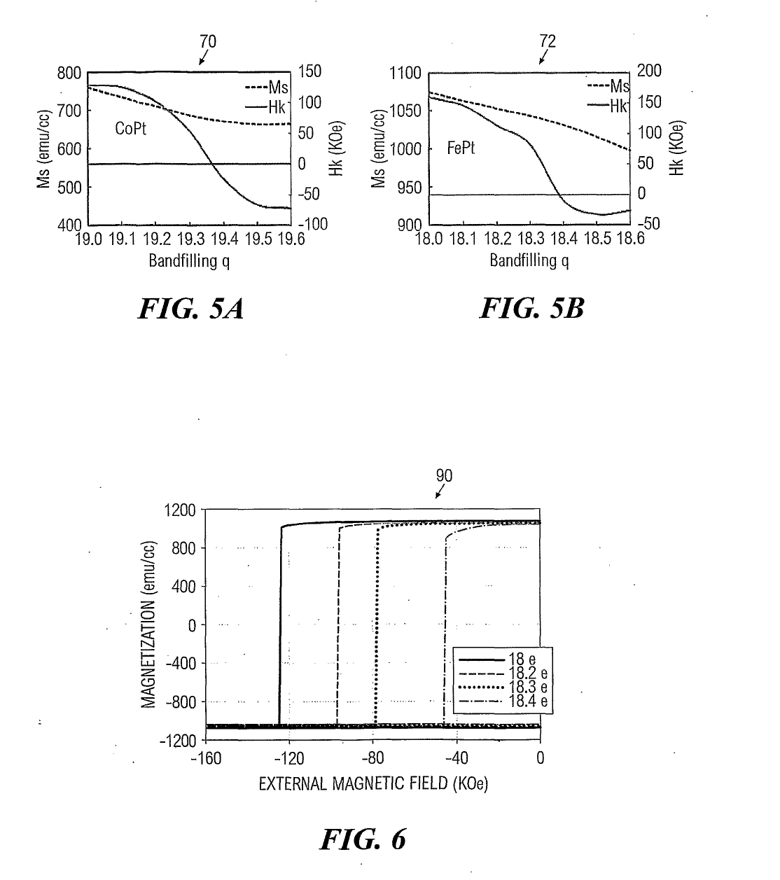

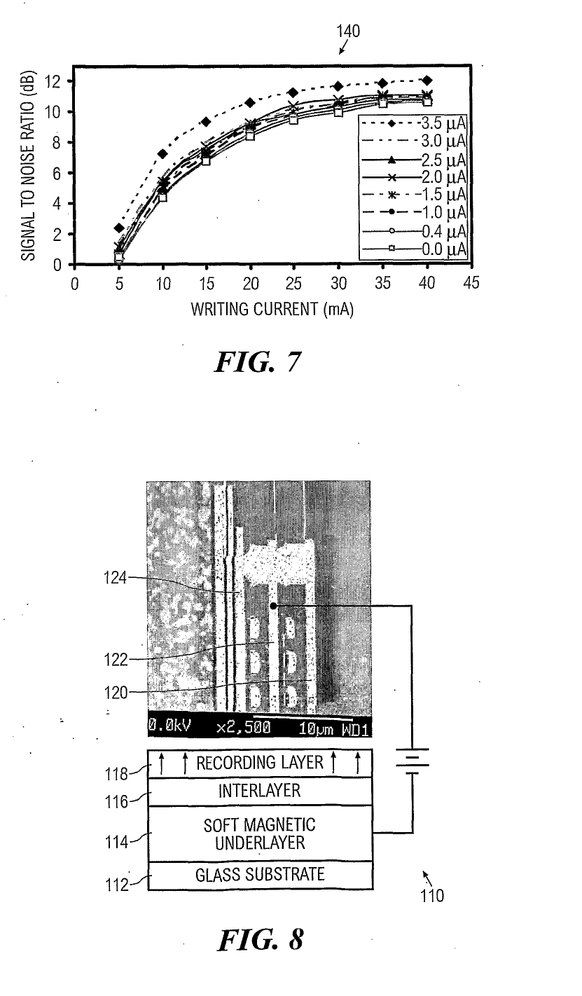

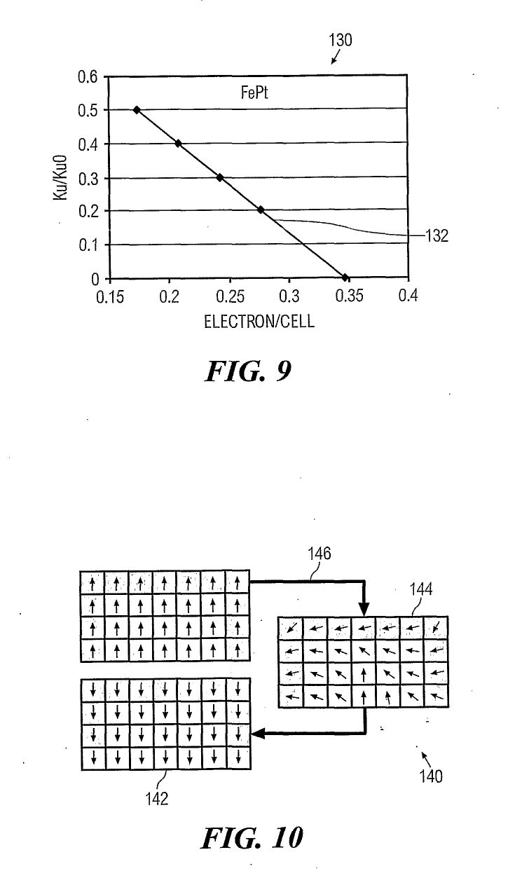

FIGS. 5A and 5B show how magnetic anisotropy energy Kᵤ of CoPt and FePt changes with band filling in accordance with an embodiment of the invention. FIG. 5A is a graph showing the response 70 for CoPt, and FIG. 5B shows the response 72 for FePt. For CoPt and FePt alloys, the extra electrons can reduce the Kᵤ very fast and only 0.35 more electrons in a unit cell will make the effective Kᵤ almost become zero (refer to FIG. 9). On the other hand, the deficiencies of electrons will increase the Kᵤ as well. Once the Kᵤ is reduced by applying negative bias, the switching field of magnetic storage media will be reduced as well. FIG. 6 shows a graph 90 illustrating the switching field changing with the band filling. A clear reduction of coercivity in FePt films caused by an increased band filling was observed. Since a deficiency of electrons can cause the increase of Kᵤ of FePt and CoPt, positive bias to magnetic storage media is not acceptable for these two type of materials, this will increase the media coercivity and therefore make the magnetic storage media harder to write. Some of media materials, such as FePd and CoPd, can use positive bias to reduce media coercivity. FIG. 7 shows a graph 140 illustrating the improved media performance by negatively biasing to magnetic storage media in accordance with an embodiment of the invention. For example, an increase of 3 dB of signal-to-noise ratio (SNR) was observed by applying a negative bias to a commercial media with a flying height of around 10 nm. FIG. 3 is a schematic drawing showing how the negative potential is applied to a magnetic storage media using conductive substrate.

FIG. 8 shows how the negative bias is applied within the device assembly 110 to the magnetic storage media using a glass substrate 112 in accordance with an embodiment of the invention. The magnetic storage media comprises a soft magnetic underlayer (SUL) 114 which is used to guide the flux from the write pole and enhance writing capability, and interlayer 116 which is for orientation and microstructure control of recording layer and a recording layer 118 which is used to recording information on top of the glass substrate 112. The read/write head shown is a cross-sectional scan showing the read/write head components such as inter alia a return pole, main pole 122 and write shield 120. The negative bias in this embodiment is applied between the magnetic storage media and the read/write head, for example the soft magnetic underlayer 114 and the main pole 122. It will be appreciated that the negative bias may be applied to other components of the read/write head assembly and the magnetic storage media. The materials used for SUL may be for example, but not limited to, Co alloys (CoZrTa, CoCrTa, etc), Fe alloys (FeCrSiB, etc), FeNi, and FeCo alloys (FeCoB, FeCoSiB, FeCoCrSiB, etc). The materials used for interlayer may be for example, but not limited to, Ru and Ru alloys (RuCr, RuB, RuSi etc), Cr and Cr alloys, and MgO, etc. The recording layer may be for example, but not limited to, CoCrPt-Oxide, FePt-Oxide, CoPt-Oxide granular media.

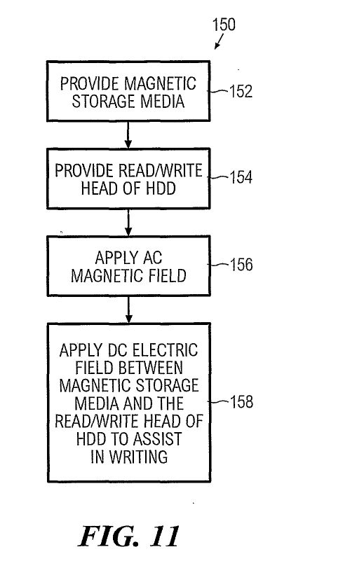

FIG. 11 is a flow chart of a method 150 in accordance with an embodiment of the invention. The method 150 as described may include providing a magnetic storage means 152 and a read/write head of a HDD 154. An AC magnetic field is applied 156 and a DC electric field is applied between the magnetic storage means and the read/write head of the HDD to assist in writing 158.

In an example, an electrically controlled magnetism in a real recording system with CoCrPt—TiO2 nanocomposite thin films are used as magnetic storage media. In a spin-stand test at 10 mA writing current, with a voltage of 3 V applied across the head-media gap during recording, the amplitude of the readback signal was almost doubled and the read back waveforms showed sharper transitions. These account for the 3 dB improvement in read back signal-noise-ratio (SNR) of the written magnetic information. The improved recording performance is mainly attributed to the reduction of anisotropy of the magnetic storage media in the presence of electrical field. Simulations were also carried out to understand the magnetization reversal process under applied electric and magnetic fields. In a spin-stand test on a recording system with a voltage of 3 V applied across the head-media gap during recording results in an appreciable reduction of media switching field. The read back waveforms showed sharper transitions and a 3 dB improvement in read back SNR was achieved as well. In order to apply electric field to a magnetic storage media, read/write heads from commercially available HDD products may be modified to allow direct electrical access to the writer or recording pole. In addition, the usually grounded slider main body may be electrically isolated also by modification. This is to prevent the presence of large electrostatic forces that can affect the flying height and stability of the slider or damaging electric discharge between slider and magnetic storage media. As the slider main body is already electrically isolated, and the alumina around the writer main pole is nonconducting, the applied electric field is strongest at the main pole region. A schematic for the experimental set-up is given in FIG. 3 and FIG. 8.

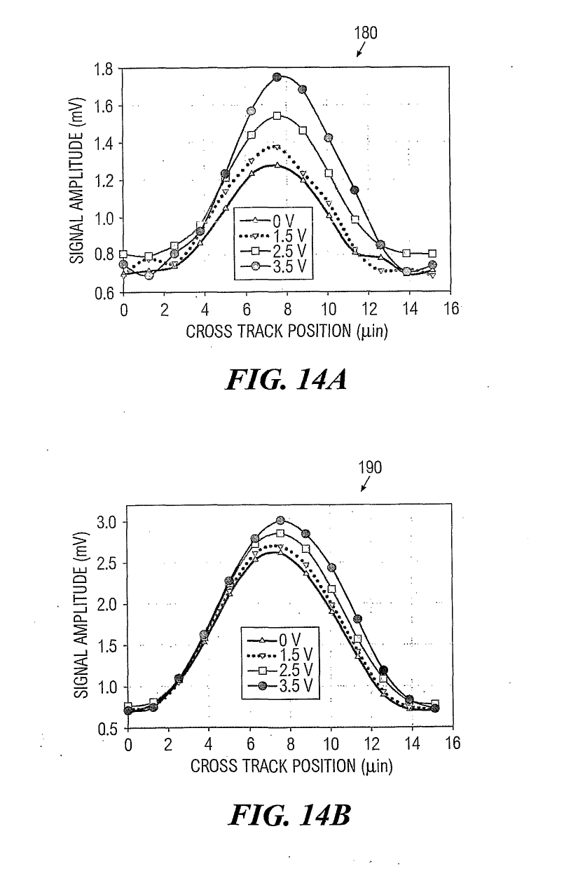

The recording and read back measurements were performed on a commercial Guzik spinstand. During the recording process, combinations of different electric potentials applied across the head media gap, for example via the said connections to the write pole as well as media substrate, with different writer currents were used. The applied electric potential was supplied by a Keithley Sourcemeter. For each experimental run, an all “ones” pattern track was first written. Subsequently, the same track is read back and the magnitude of the read back pattern was recorded. During the read back process, no gap electric potential was applied. FIG. 14A-B are graphs showing the track profiles measured under different writer pole biases at a) 10 mA head writing current, and b) 40 mA head writing current, respectively. The writing current at 10 mA is very close to the coercivity current and the signal amplitude at 3.5V bias is almost doubled to that without any bias. At the saturation region of 40 mA writing current, the electrical biased writing shows larger signal amplitude and also wider magnetic write width. Without any noticeable change of writer flying height during the writing process, the static electrical bias does enhance the writability of the write pole. Near the coercive current at 10 mA writing in FIG. 14A, the writability is very sensitive to the effective field change and the signal amplitude with 3.5 V bias almost doubles the one without bias. In FIG. 14B, the electrical bias at saturated current writing increases the signal amplitude and the magnetic write width of the track. It must be mentioned that in experiments, the application of gap electric potential did not result in noticeable change in flying height as the read back amplitude did not increase when increased electric potential was applied during read back without applied electric field during the writing process, as would be the case when the flying height changes lead to increased read back signal amplitude due to reduced magnetic spacing. The increase in read back amplitude was only affected by the electric potential applied during writing process. In an example, a 3 dB gain read-back SNR is achievable with the presence of a 3.5 V gap potential during writing.

Density-functional calculations show spin dependent screening of the electric fields led to spin imbalance of the excess surface charge. As the electric field does not penetrate into the bulk of metals, the excess electric charge is confined to a depth of lattice constant level. Because the excess charges remained localized near the surface atoms, the effect of local properties such as inter-atomic bonding or the atomic magnetic moments may conceivably be quite large. The electrical field distribution at the metallic grain surfaces under the bias from writer pole can be calculated from the output data of electric force over electrical field. In an embodiment, the electric conductive pole is separated by the air gap and media overcoat material to reach the metallic grains grounded through metallic underlayer. The metallic grains are separated by dielectric grain boundary materials. In an embodiment, in order to have significant magnetic switching field reduction, the charge density may reach 0.3 to 0.5 electrons per unit cell for FePt material for example. In a magnetic storage media structure, the overcoat and the metallic underlayer are connected by the metallic grain and the dielectric grain boundary material. Inside the metallic grains and underlayer, there is no electric potential difference. Due to the electrical shielding effect of metallic grains, it is very hard for the dielectric grain material to lead down the electrical field down to the underlayer. The higher permittivity grain boundary material helps to lead down more of the electrical field downwards. With this configuration, although the higher permittivity overcoat material traps more electrons in each unit cell, the charge density decreases relatively quickly and only the top few atoms of each grain traps a meaningful number of electrons for magnetic switching field reduction.

It will be appreciated that it has been shown that contribution of any heating effects of the gap current in the increase in recording capability is not significant in comparison to the electrically modified anisotropy effects. Based on experimental conditions the power from the heating effect is estimated to 9 μW for a 3 μA gap current. If this heating power is transferred to the magnetic storage media, the energy absorbed when the pole passes the magnetic bit is 6.74×10⁻¹⁴ J. Such heating power roughly raises the magnetic storage media temperature by less than 1.6 K. This temperature rise is not significant and is not high enough to provide significant assisted writing. Therefore the improvement of recording performance is not due to the heating effect of the gap current but is the result of a pure electric-field induced effect. Thus, the effect is in the influence of an electric field on electron filling of the magnetic storage media, which reduces the magnetic anisotropy of the magnetic storage media. Additionally, substantial electric-field induced effects may be present in nanosystems where the surface-to-volume ratio is high, as in the case of magnetic thin film media with grain size of about 8 nm or less.

Density-functional calculations were also applied to ferromagnetic Fe(001), Ni(001), and Co(0001) films in the presence of an external electric field. These showed spin-dependent screening of the electric fields led to spin imbalance of the excess surface charge. As the electric field does not penetrate into the bulk of metals, the excess electric charge is confined to a depth of lattice constant level. Because the excess charges remain localized near the surface atoms, the effect on local properties such as the inter-atomic bonding or the atomic magnetic moments may conceivably be quite large. This offers us an opportunity to modify the intrinsic magnetic properties by applying electrical field. The applied electric field modifies the magnetic properties of magnetic storage media by trapping electrons into the surface of magnetic grains. The assisted recording approach discussed herewith is named trapping electron assisted magnetic recording (TEAMR).

To understand the effect of trapped or induced electric charges at the interface on the magnetization reversal process of magnetic grains, a simple model is used illustrate and to represent individual magnetic grains whereby the topmost layer of atoms of the magnetic grain has been modified to be magnetically soft, for example with a lower anisotropy Kᵤ₁ for the surface portions, by the applied electric field. Simulated hysteresis loops of a conventional media with different Kᵤ₁ for the surface portion are given in the graph 170 shown in FIG. 13, where Kᵤ₀ is the bulk anisotropy. It is shown that the switching field can be continuously reduced by reducing Kᵤ₁ of the surface portion. If the anisotropy Kᵤ₁ of the surface portion is reduced to 10% of the bulk value, the switching field can be reduced to less than half of the bulk value. With 30% reduction, for example close to the estimated value with the presence of electric field, of anisotropy Kᵤ₁ for the surface portion, about 13.5% decrease of switching field is indicated by the simulation, which is close to the 13% reduction of the writing saturation current observed in experiments. This enables reduction of media switching field while at the same time the same thermal stability is maintained.

FIG. 10 illustrates the suggested switching mechanism 140 by which the electric field 146 induced electron trapping resulted first in reduced anisotropy of the topmost layer 144. FIG. 10 illustrates a switching mechanism of individual magnetic grains with an applied electric field induces electron trapping and reduced anisotropy of the topmost layer in accordance with an embodiment of the invention. Under an applied magnetic field, this magnetically softened layer subsequently switches magnetization direction prior to and more easily than the inner atoms, and in the process helps propel the switching process of the inner atoms and eventually, the whole grain 142. The reduction of switching field is realized by a non-uniform switching process which is similar to the concept of exchange coupled composite (ECC) media and analogous to that of enclosed ECC structure. The softened surface portion can also narrow down the media switching field distribution and therefore sharper transitions are observed. In an example, hysteresis loops of the FePt media with different Kᵤ for the surface portion has shown that the switching field may be continuously reduced by reducing the anisotropy Kᵤ of the surface portion. As for ECC type structures, the volume ratio of soft magnetic layer to hard magnetic layer is preferable relatively large for more reduction of magnetic switching field. Since the penetration depth of metal is at the lattice constant level, only the outmost one layer of atoms of the grain trap free electrons. The volume ratio of soft to hard reduces when the grain size becomes larger, which implies TEAMR has less switching field reduction to the relatively bigger grains. The TEAMR media does not require fabricating the soft magnetic layer with a strong exchange coupling. The soft layer of ECC media reduces the overall thermal stability of recording layer and increases the head keeper spacing resulting in lower effective head field. In addition, the exchange coupling strength of TEAMR is not a concern because the atoms of one grain are strongly exchange coupled.

In an embodiment, system implementation of TEAMR requires little modification to conventional recording configuration, where a change to conventional heads is the electrical disconnection of the writer pole from the common ground of the slider body and has a separate wire out to control the electrical bias. As the spacing between the writer pole and the grain top surface is much less than the head keeper spacing, the bubble size of the electrical field is smaller than that of the magnetic field. Because both field bubbles are mainly determined by the size of the writer pole, the bubble size difference is small. If it is necessary to enlarge the electrical field bubble for optimization of effective field, the non-magnetic metallic layer can be added on the side surfaces of the writer pole. The materials of the overcoat and the grain boundary on the magnetic storage media may be high permittivity materials to ensure the charge density at the surfaces of the grains. For TEAMR writing within an embodiment, the outmost layer of grain atoms is magnetically softer than the grain core and the magnetic switching is preferred to start near the grain boundary, to have a sharper field gradient. As such, TEAMR assists the granular media to further reduce the grain number per bit through improved quality of the writing field, which contributes to areal density: Additionally, for maximizing writing capability, the media may be bit patterned media (BPM). Filler material for the planarization of BPM grooves can be high permittivity materials as well. Due to the relatively larger island to island spacing, the electrical shielding effect from protruded islands is much smaller than the case of granular media. The electrical field can go deeper towards the bottom of BPM islands. There are more areas on the side surfaces of BPM islands trapping electrons at sufficiently high charge density. This increases the interface area of the soft to hard exchange coupling and also total volume of soft layer, which both are beneficial for switching field reduction. The media overcoat may assist in producing high charge density for metallic grains trapping free electrons. At higher areal density where there is little or no room for the media overcoat, the dielectric charge producing layer can be put under the metallic grains, with corresponding changes to media fabrication process.

In summary, the electrically controlled magnetism at spin-stand level is applied in real magnetic recording systems. An electrical bias is applied to the main pole of the write head with the media and the other part of the head slider grounded. As the main pole area is relatively small, the electrostatic force produced by electrical potential is a few orders smaller than the air bearing force at rear pad. Therefore, it will not affect the flying performance of the head slider. At the nanometer head media spacing, a relatively strong electrical field is produced in the head media interface. By using a sufficiently high electric field across the head-media gap, electrons are trapped into the surface of magnetic grains in the media. The strong electrical field traps free electrons to accumulate at the interfacial surfaces of metallic magnetic grains. The trapped electrons are localized in the surface atoms of magnetic grains and alter the valance-electron band filling of those surface atoms. The extra band-filling electrons, trapped electrons reduce the anisotropy energy of the magnetic grains and in turn reduce the switching field of the magnetic storage media which makes it easier to be magnetically switched. The softened portions in the magnetic grains narrow down the media switching field distribution and therefore reduce the transition width. The gain in SNR is due to better write-ability and narrower transitions. The demonstrated concept is easily implementable through slight modification to existing recording heads. It will be appreciated that more significant improvement can be observed for higher recording density media with smaller grain size where surface-to-volume ratio is higher. This electric field assisted approach with demonstrated 3 dB SNR gain makes it a viable alternative to other more complex assisted recording schemes such as HAMR or microwave assisted recording.

In an embodiment, a DC electric field is negatively biased to the magnetic storage media. The magnetic storage media is a material such as for example a metal material such as CoCrPt, FePt and the like. The DC field is applied to trap electrons on the surface of the grains by which the magnetic storage media is composed. The trapped electrons effectively reduce the anisotropy energy of the magnetic storage media and therefore make the media easier to write. The negative DC potential is directly applied to the magnetic storage media and at the same time, the write pole is grounded. Due to the low flying height which can be less than 8 nm for example, a low potential can generate high electrical field at the media surface, and therefore can trap electrons on the magnetic storage media surface. The media used may be CoCrPt+SiO₂(TiO₂), FePt, CoPt, and the like.

While embodiments of the invention have been described and illustrated, it will be understood by those skilled in the technology concerned that many variations or modifications in details of design or construction may be made without departing from the present invention.

1. A magnetic recording system comprising:
a magnetic storage media having a recording layer comprising a material having magnetic particles having a magnetic anisotropy energy that changes in the presence of an electrical field;
a write head having a write pole for applying an AC magnetic field for writing magnetic information to the magnetic storage media; and
a power supply for generating a negative DC electrical bias between the magnetic storage media and the write head for applying a DC electric field to the recording layer to reduce the magnetic anisotropy energy and switching field of the material of the recording layer during the writing of magnetic information to the magnetic storage media.

2. The magnetic recording system of claim 1, wherein the magnetic storage media further comprises a soft magnetic underlayer under the recording layer.

3. The magnetic recording system of claim 2 wherein the magnetic storage media further comprises an interlayer between the recording layer and the underlayer.

4. The magnetic recording system of claim 1, wherein the material of the recording layer is CoCrP(SiO₂), CoCrPt(TiO₂), FePt and FePt with TiO₂, FePt and FePt with SiO₂, FePt and FePt with any oxide, CoPt and CoPt with TiO₂, CoPt and CoPt with SiO₂, or CoPt and CoPt with any oxide.

5. The magnetic recording system of claim 1, wherein the negative bias is applied to the magnetic storage media to provide a source of free electrons for the magnetic particles in the recording layer to trap the electrons and fill an electronic shell of the magnetic particles to reduce the magnetic anisotropy energy of the magnetic particles.

6. The magnetic recording system of claim 5, wherein the magnetic particles that trap electrons and fill an electronic shell of the magnetic particle reduces the switching field of the recording layer for the write head to write magnetic information in the magnetic storage media.

7. The magnetic recording system of claim 6 wherein the magnetic particles that trap electrons and fill an electronic shell of the magnetic particle increases the signal to noise ratio of the recording layer magnetic particles.

8. The magnetic recording system of claim 5, wherein the magnetic particles in the recording layer that trap the free electrons to fill an electronic shell of the magnetic particles are located at a surface of the recording layer.

9. The magnetic recording system of claim 5, wherein the magnetic particles of the recording layer are at a surface of the recording layer.

10. The magnetic recording system of claim 1, wherein the write pole is biased preferably with higher potential than the recording layer of magnetic media.

11. The magnetic recording system of claim 1, wherein the space between write head and the magnetic storage media is less than 20 nm.

12. The magnetic recording system of claim 1, wherein the material of the recording layer has a Tc above room temperature.

13. The magnetic recording system of claim 1, wherein the magnetic particles of the recording layer are separated by dielectric grain boundary materials.

14. The magnetic recording system of claim 1, wherein the bias between the magnetic storage media and the write head is below 5V.

15. A magnetic recording method comprising:
providing a magnetic storage media having a recording layer comprising a material having magnetic particles having a magnetic anisotropy energy that changes in the presence of an electrical field;
applying an AC magnetic field for writing magnetic information to the magnetic storage media with a write head having a write pole; and
generating a negative DC electrical bias between the magnetic storage media and the write head for applying a DC electric field to the recording layer to reduce the magnetic anisotropy energy and switching field of the material of the recording layer during the writing of magnetic information to the magnetic storage media.

16. The method of claim 15 further comprising arranging the magnetic storage media to further comprise a soft magnetic underlayer under the recording layer.

17. The method of claim 16 further comprises arranging the magnetic storage media to further comprise an interlayer between the recording layer and the underlayer.

18. The method of claim 15 wherein the material of the recording layer is CoCrP(SiO₂), CoCrPt(TiO₂), FePt and FePt with TiO₂, FePt and FePt with SiO₂, FePt and FePt with any oxide, CoPt and CoPt with TiO₂, CoPt and CoPt with SiO₂, or CoPt and CoPt with any oxide.

19. The method of claim 15, further comprising applying the negative bias to the magnetic storage media to provide a source of free electrons for the magnetic particles in the recording layer to trap the electrons and fill an electronic shell of the magnetic particles to reduce the magnetic anisotropy energy of the magnetic particles.

20. The method of claim 19 wherein the magnetic particles that trap electrons and fill an electronic shell of the magnetic particle reduces the switching field of the recording layer for the write head to write magnetic information in the magnetic storage media.

21. The method of claim 20 wherein the magnetic particles that trap electrons and fill an electronic shell of the magnetic particle increases the signal to noise ratio of the recording layer magnetic particles.

22. The method of claim 19 wherein the magnetic particles in the recording layer that trap the free electrons to fill an electronic shell of the magnetic particles are located at a surface of the recording layer.

23. The method of claim 15 wherein the magnetic particles of the recording layer are at a surface of the recording layer.

24. The method of claim 15 wherein the write pole is biased preferably with higher potential than the recording layer of magnetic media.

25. The method of claim 15 wherein the space between write head and the magnetic storage media is less than 20 nm.

26. The method of claim 15 wherein the material of the recording layer has a Tc above room temperature.

27. The method of claim 15 wherein the magnetic particles of the recording layer are separated by dielectric grain boundary materials.

28. The method of claim 15 wherein the bias between the magnetic storage media and the write head is below 5V.

29. A magnetic storage media for use in the system of claim 1.

30. A magnetic storage media comprising:
a recording layer comprising a material having magnetic particles having a magnetic anisotropy energy that changes in the presence of an electrical field; and
a soft magnetic underlayer under the recording layer.

31. The magnetic storage media of claim 30 wherein the recording layer traps electrons and fills an electronic shell of the magnetic particles to reduce the magnetic anisotropy energy of the magnetic particles when the magnetic storage media is arranged to have a negative bias applied to the magnetic storage media to provide a source of free electrons for the magnetic particles in the recording layer.

32. The magnetic storage media of claim 30 wherein the material of the recording layer is CoCrP(SiO₂), CoCrPt(TiO₂), FePt and FePt with TiO₂, FePt and FePt with SiO₂, FePt and FePt with any oxide, CoPt and CoPt with TiO₂, CoPt and CoPt with SiO₂, or CoPt and CoPt with any oxide.

33. The magnetic storage media of claim 30 further comprising an interlayer between the recording layer and the underlayer.

34. The magnetic storage media of claim 33 wherein the material of the interlayer is Ru, Ru alloys, RuCr, RuB, RuSi, Cr, Cr alloys, or MgO.

35. The magnetic storage media of any claim 30 wherein the material of the underlayer is Co alloys, CoZrTa, CoCrTa, Fe alloys, FeCrSiB, FeNi, FeCo alloys, FeCoB, FeCoSiB, or FeCoCrSiB.

36. A hard disk drive for use in the system of claim 1.

37. A hard disk drive comprising:
a magnetic storage media having a recording layer comprising a material having magnetic particles having a magnetic anisotropy energy that changes in the presence of an electrical field; and
a write head having a write pole for applying an AC magnetic field for writing magnetic information to the magnetic storage media, and arranged to receive a power supply for generating a negative DC electrical bias between the magnetic storage media and the write head for applying a DC electric field to the recording layer to reduce the magnetic anisotropy energy and switching field of the material of the recording layer during the writing of magnetic information to the magnetic storage media.

38. The magnetic recording system of claim 1, wherein the write pole is be biased with lower potential to the recording layer for some media materials.

39. The method of claim 15, wherein the write pole can be biased with lower potential to the recording layer for some media materials.
